(19) United States
(12) Patent Application Publication
(10) Pub. No.: US 2026/0115634 A1
(43) Pub. Date: Apr. 30, 2026

(54) FILTER APPARATUS AND METHOD

(71) Applicant: Steve C. Benesi, Novato, CA (US)

(72) Inventor: Steve C. Benesi, Novato, CA (US)

(21) Appl. No.: 19/145,216

(22) PCT Filed: Feb. 19, 2024
(86) PCT No.: PCT/US2024/016345

§ 371 Date: Jul. 2, 2025

Related U.S. Application Data
(60) Provisional application No. 63/485,961, filed on Feb. 20, 2023.

(51) Int. Cl. B01D 33/23; B01D 33/48

(52) U.S. Cl. CPC B01D 33/23; B01D 33/48

(57) ABSTRACT

A filtration apparatus that can include a filtering device can include disc sectors configured so that a vacuum can be applied to some disc sectors while compressed fluid is passed from a disc sector so that the fluid is passed into and/or through of at least one adjacent disc sector while that at least one disc sector is passed through a bath of the device configured to retain a slurry. Processes to retrofit a pre-existing filter device to include new disc sectors to form an embodiment of the filtration apparatus can include replacing old disc sectors with new disc sectors that are configured so that a vacuum can be applied to some disc sectors while compressed fluid is passed into and/or through at least one adjacent disc sector while that at least one adjacent disc sector is passed through a bath of the device configured to retain a slurry.

### CROSS-REFERENCE TO RELATED APPLICATIONS

This application claims priority to U.S. Provisional Patent Application No. 63/485,961, which was filed on Feb. 20, 2023.

### FIELD

The present innovation is directed to filtration systems, filter devices, processes for retrofitting filter devices, and methods of making and using filter devices.

### BACKGROUND

Filter devices are often used in mineral processing, processing of starch or chemical products, processing of agglomerated material, power generation applications, and other industries to remove solid materials from a slurry (e.g. a liquid having solid particulates entrained therein or a gas having solid particulates entrained therein). Examples of such devices can be appreciated from U.S. Pat. Nos. 6,409,929, 6,006,554, 4,330,405, 4,207,190, 4,152,267, 3,869,389, 3,471,026, 3,291,312, 3,250,396, and 1,538,980 and U.S. Patent Application Publication Nos. 2018/0326357, 2018/0071667, 2017/0341004, 2016/0121245, 2016/0074784, 2015/0266780, 2015/0184099, 2014/0346104, 2013/0161252, 2013/0008006, 2011/0131873, 2011/0011785, 2010/0115899, 2009/0139193, 2008/0314012, 2007/0017196, 2005/0067342, and 2004/0177471. Other examples of filter devices and mechanisms that can be used in such devices can be appreciated from my International Publication No. WO 2020/185484, my U.S. Pat. Nos. 7,011,741, 6,521,135, 6,491,817, 6,159,359, 5,477,891, 5,292,434, 5,059,318, and U.S. Patent Application Publication Nos. 2006/0102545, 2006/0027509, 2006/0283785, 2007/0256984, and 2022/0143536.

### SUMMARY

A filter apparatus, filtering method, filtering device, and methods of making and using the same are provided to provide improved filtering operation to separate particular material from a liquid that is within a slurry. Embodiments can be configured to facilitate improved operational time and a reduction in maintenance. For example, conventional filter devices can require manual pressure washing of filter media every 2 hours to facilitate cleaning of the filter media to avoid binding and improve operational performance. During this cleaning, the filter device is not operated to perform filtering, which greatly impacts the operational capacity of the conventional device. In contrast, embodiments of my filter apparatus can permit such washing to be stopped or to delay such manual washing so it occurs much less frequently (e.g. once a week, once a day, other longer time period).

A filter apparatus is provided that includes at least one rotatable disc that is rotatable within a reservoir of a slurry bath sized to retain a slurry within the reservoir. Each disc includes a plurality of disc sectors. The disc can be configured so that each disc sector travels through the reservoir during a full revolution of the disc when the disc rotates. Each disc sector can be configured so that when the disc sector is above the reservoir, a cavity of the disc sector defined between filter media of the disc sector is exposed to a vacuum while an adjacent disc sector that is below the disc sector and positioned within the reservoir receives a pressurized fluid within its cavity. The pressurized fluid can be a flow of air or other gas, for example. The pressurized fluid can be fed to the disc sector via a tube manifold or pressurized fluid manifold that is connectable to the disc sector. The pressurized fluid manifold can be positioned to extend along and/or through the shaft for connecting a source of gas or fluid (e.g. a compressor, etc.) to the disc sectors.

The pressurized fluid that can be fed to the disc sector 20a can pass from the cavity of the disc sector 20a to an adjacent disc sector while that adjacent disc sector is within the reservoir of the slurry bath so it passed into and through the filter media of the adjacent disc sector to the reservoir via the filter media to clean the interstices or pores of the filter media while the adjacent disc sector moves through the reservoir. The path of travel of each disc sector within the reservoir can be such that the compressed fluid passes out of that disc sector's filter media for a portion of the time the sector passes through the reservoir (e.g. for 5% to 50% of the rotational path of the disc as it rotates through the reservoir or other subpart of the entire time that the disc sector is moved through the slurry bath during a full revolution of the disc of that disc sector) or throughout the entire time that the disc sector is moved through the reservoir.

Processes for retrofitting a conventional filter device to include new disc sectors is also provided. The new sectors can replace old disc sectors of a disc. The new disc sectors can be configured to so that each new disc sector travels through the reservoir during a full revolution of the disc when the disc rotates after the new disc sectors are installed onto the disc to replace the disc's old disc sectors. Each new disc sector can be configured so that when the new disc sector is above the reservoir, a cavity of the new disc sector defined between filter media of the new disc sector is exposed to a vacuum while an adjacent new disc sector that is below the new disc sector and positioned within the reservoir receives a pressurized fluid within its cavity. The pressurized fluid can be a flow of air or other gas, for example. The pressurized fluid can pass from the cavity of the new disc sector within the reservoir to the reservoir via the filter media to clean the pores or interstices of the filter media while the new disc sector moves through the reservoir. The path of travel of each new disc sector within the reservoir can be such that the compressed fluid passes out of that new disc sector's filter media for a portion of the time the new disc sector passes through the reservoir (e.g. for 5% to 50% of the rotational path of the disc as it rotates through the reservoir or other subpart of the entire time that the disc sector is moved through the slurry bath during a full revolution of the disc of that new disc sector, for 5% to 20% of the rotational path of the disc as it rotates through the reservoir or other subpart of the entire time that the disc sector is moved through the slurry bath during a full revolution of the disc of that new disc sector, etc.) or throughout the entire time that the new disc sector is moved through the reservoir.

In some embodiments, a filtration device can be provided that includes at least one rotatable disc that is rotatable so disc sectors are insertable into a slurry bath positioned adjacent the at least one rotatable disc. The disc sectors can be configured to form filter cakes comprised of solid particulate material of the slurry via rotation of the at least one rotatable disc about a shaft. Each of the disc sectors can have: (a) a frame connected to at least one filter element wherein the frame has a cavity and the frame is connectable to the shaft about which the disc rotates so that a vacuum is appliable to the cavity and a pressurized fluid is passable to the disc sector, (b) a first pressurized fluid conduit connected to the frame for conveying pressurized fluid to the disc sector wherein a disc sector feed opening of the first pressurized fluid conduit can be in fluid communication with the cavity so that the pressurized fluid is passable through the first pressurized fluid conduit and into the cavity, and (c) a second pressurized fluid conduit connected to the frame such that an inlet of the second pressurized fluid conduit is positioned to receive the pressurized fluid for feeding the pressurized fluid through an inner passageway of the second pressurized fluid conduit so that the pressurized fluid is outputtable into a cavity of an adjacent one of the disc sectors while the adjacent disc sector is within the slurry bath and/or after the at least one filter element of the adjacent disc sector has undergone filter cake discharge for cleaning of the at least one filter element of the adjacent disc sector.

In some embodiments, the disc sectors can be provided so that a disc sector that has just passed below a scraper during a revolution of the disc receives pressurized fluid from an upper adjacent sector that is undergoing scraping and/or about to undergo scraping. During a revolution, each disc sector may receive pressurized fluid from an immediately adjacent disc sector during a revolution after that disc sector has undergone scraping via a scraper that is positioned to contact the filter cake on a filter element of the disc sector to remove the filter cake from the disc sector.

In some embodiments, the filtration device can include various other features. For example, embodiments can include the shaft wherein the shaft has a tube manifold connectable to the disc sectors. Embodiments can also include at least one filter cake discharge chute positionable adjacent the disc to receive filter cake discharged from the disc sectors.

A cake discharge frame having multiple cake discharge chutes defined therein for receipt of the filter cakes can also be provided. The cake discharge frame can be connectable to the slurry bath. The at least one disc can includes multiple discs and the cake discharge frame can be configured to define the discharge chutes so that there are gaps positioned between the discharge chutes. Each of the discs can be positionable within a respective one of the gaps.

In some embodiments, the second pressurized fluid conduit can have a disc sector feed opening in communication with a cavity of the adjacent sector.

In some embodiments, each of the disc sectors can have a check valve positioned in fluid communication with the inlet of the second pressurized fluid conduit. The check valve can be adjustable to a closed position in response to the passing of the pressurized fluid to the disc sector to direct the pressurized fluid through the second pressurized fluid conduit so the pressurized fluid is passed to the adjacent disc sector.

A method of filtering is also provided. Embodiments of the method can include rotating a disc having disc sectors so that each of the disc sectors has pressurized fluid passed into the disc sector for being directed into one of the disc sectors adjacent to the disc sector after the adjacent disc sector has had filter cake discharged from at least one filter element of the adjacent disc sector to facilitate cleaning of pores or interstices of filter media of at least one filter element of the adjacent disc sector.

In some embodiments, the rotating can be performed such that the pressurized fluid is passed into the adjacent disc sector while the adjacent disc sector is rotated through a slurry bath.

The method can also include passing the pressurized fluid out of the adjacent disc sector and into the slurry bath while the adjacent disc sector is passed through the slurry bath. In some embodiments, the method can be performed so that filter cake from the at least one filter element is removed (e.g. via scraping) before the adjacent disc sector is passed into the slurry bath. For example, the removing of the filter cake can include scraping the filter cake off of the at least one filter element via at least one scraper.

The method can also include other steps related to installation of retrofitting of a filtration device. For example, the method can include installing the disc sectors on a rotatable shaft to form the disc. The method can also include installing a cake discharge frame on a slurry bath adjacent the disc so that the disc is passable through a gap defined between adjacent, spaced apart discharge chutes.

The method can also include other steps related to filtration. For example, the method can include applying a vacuum to the disc sectors during the rotating of the disc.

In some embodiments, the method can include feeding the pressurized fluid into each of the disc sectors of the disc during a revolution of the disc so that the pressurized fluid is directed from the disc sector to a cavity of the adjacent disc sector so that the pressurized fluid is passed into the adjacent disc sector after the adjacent disc sector has had filter cake discharged from at least one filter element of the adjacent disc sector to facilitate cleaning of pores or interstices of filter media of at least one filter element of the adjacent disc sector. This feeding of pressurized fluid can occur so that the pressurized fluid is passed into the adjacent disc sector before the disc sector is passed into the slurry bath and/or while the disc sector is initially passed into the slurry bath (e.g. for an initial period of time in which the disc sector may be passed through the slurry bath and physically contact the slurry within the slurry bath). This initial time period in which the pressurized fluid is passed into the adjacent disc sector can be more than 0 seconds after the adjacent disc sector enters the slurry of the slurry bath and can also be less than the entirety of the time in which the disc sector is within the slurry bath during a revolution of the disc (e.g. can be for a few seconds or can be for less than 5 seconds and more than 0 seconds, etc.).

In some embodiments, a filtration method can include passing pressurized fluid into a first disc sector of a disc that is rotatable about a horizontal shaft such that the disc is rotatable adjacent to a slurry bath and passing the pressurized fluid from the first disc sector to a second disc sector of the disc that is adjacent the first disc sector so that the pressurized fluid is passed into a cavity of the second disc sector to clean pores or interstices of filter media of at least one filter element of the second disc sector.

Embodiments of the method can also include passing the second disc sector through the slurry bath for filtering of particulates from liquid of slurry within the slurry bath.

In some embodiments, the passing of the pressurized fluid from the first disc sector to the second disc sector so that the pressurized fluid is passed into the cavity of the disc sector to clean pores or interstices of filter media of the at least one filter element of the second disc sector can include: passing the pressurized fluid through a pressurized fluid conduit connected between the first disc sector and the second disc sector while the second disc sector is within the slurry bath and/or after filter cake has been discharged from at least one filter element of the second disc sector, the pressurized fluid conduit being positioned adjacent external sides of the first disc sector and the second disc sector.

A process of retrofitting a filtration device is also provided. The process can include connecting disc sectors to a rotatable shaft to form at least one rotatable disc that is rotatable so the disc sectors are insertable into a slurry retained in a slurry bath positioned adjacent the at least one rotatable disc during rotation of the shaft, the disc sectors configured to form filter cakes comprised of solid particulate material of the slurry via rotation of the at least one rotatable disc about the shaft. Each of the disc sectors can have: (a) a frame connected to at least one filter element wherein the frame has a cavity and the frame is connectable to the shaft about which the disc rotates so that a vacuum is appliable to the cavity and a pressurized fluid is passable to the disc sector, (b) a first pressurized fluid conduit connected to the frame for conveying pressurized fluid to the disc sector wherein a disc sector feed opening of the first pressurized fluid conduit can be in fluid communication with the cavity so that the pressurized fluid is passable through the first pressurized fluid conduit and into the cavity; and (c) a second pressurized fluid conduit connected to the frame such that an inlet of the second pressurized fluid conduit is positioned to receive the pressurized fluid for feeding the pressurized fluid through an inner passageway of the second pressurized fluid conduit so that the pressurized fluid is outputtable into a cavity of an adjacent one of the disc sectors while the adjacent disc sector is within the slurry bath and/or after the at least one filter element of the adjacent disc sector has undergone filter cake discharge for cleaning of the at least one filter element of the adjacent disc sector.

Embodiments of the retrofitting process can also include other steps. For example, the disc sectors can be provided, old disc sectors can be removed from a shaft, and/or the providing of a cake discharge frame having multiple cake discharge chutes defined therein and installing such a cake discharge frame in or adjacent a slurry bath can be utilized in some embodiments.

These and other objects, aspects and advantages of the present invention will be better appreciated in view of the drawings and following detailed description of certain exemplary embodiments thereof.

### BRIEF DESCRIPTION OF THE DRAWINGS

Exemplary embodiments of filtering devices, filtration apparatuses, and embodiments of methods for making and using the same are shown in the accompanying drawings. It should be understood that like reference numbers used in the drawings may identify like components.

FIG. 1 is a schematic diagram of a first exemplary embodiment of a filtration system having at least one filter apparatus 1.

FIG. 2 is perspective view of a first exemplary embodiment of a filter apparatus 1.

FIG. 3 is a schematic diagram of a disc 20b of disc sectors 20a of the first exemplary embodiment of a filter apparatus 1 positioned for rotation through a reservoir of a slurry bath 14.

FIG. 4 is a schematic illustration of an exemplary embodiment of a sector 20a that can be included in the disc 20b of disc sectors 20a of the first exemplary embodiment of a filter apparatus 1, which includes flow path indicia to indicate a flow path of fluid when the sector is experiencing a vacuum for filtration of particulate media from the slurry of the slurry bath.

FIG. 5 is schematic illustration of disc sectors 20a of the first exemplary embodiment of a filter apparatus 1.

FIG. 6 is schematic illustration of disc sectors 20a of the first exemplary embodiment of a filter apparatus 1.

FIG. 7 is a flow chart illustrating a first exemplary process for retrofitting a filter device to have new disc sectors 20a for use in filtration operations.

FIG. 8 is a schematic top view of an exemplary embodiment of a filter cake discharge apparatus for positioning in or on a slurry bath 14 that can be utilized in the first exemplary embodiment of a filter apparatus 1.

FIG. 9 is a perspective schematic view of the exemplary embodiment of a filter cake discharge apparatus for positioning in or on a slurry bath 14 that can be utilized in the first exemplary embodiment of a filter apparatus 1.

### DETAILED DESCRIPTION OF EXEMPLARY EMBODIMENTS

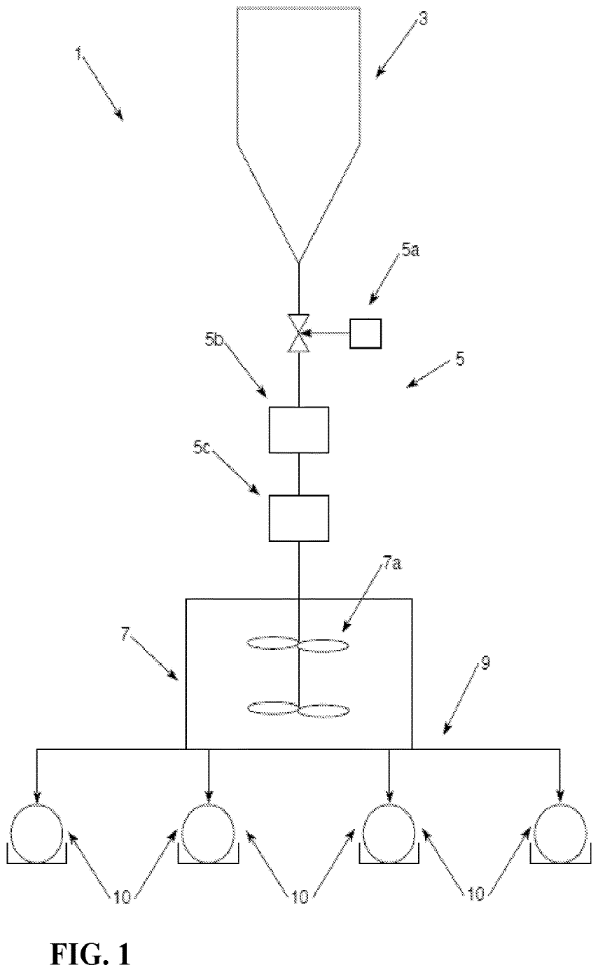

Referring to FIGS. 1-9 a processing facility can include a filtration system 1 that has one or more filtering devices 10, which can also be referred to as filtration devices 10. The filtration system 1 can utilize a slurry-based system for recovering minerals or other desired solid particulates (e.g. particular type of rock or ore or a collection of different solid particulates, recovery of filtrate as valuable product, tailings, etc.). For example, the solid particulates within the slurry can have base metal concentrates, iron ore, chromite, copper, gold, cobalt, nickel, zinc, lead, pyrite, silver, or and/or other solid material. As another example, the solid particulates can include starch, food product additives, precipitates formed from a chemical process, or be another type of solid material entrained within a fluid that is desired to be removed from the fluid.

In some embodiments, the filtration system 1 can utilize a tank 3 that is positioned to form a slurry or adjust a concentration of solid particulates within the slurry so the slurry has a concentration of solid particulates that is within a pre-scribed range (e.g. a preselected range). In some embodiments, the tank 3 can be configured a process slurry control tank or a slurry control vessel. The slurry from within the tank 3 can be fed via a slurry feed conduit 5 so the slurry is transported from the tank 3 to a mixer unit 7 or a slurry filter tank, which can have at least one mixer unit (e.g. at least one mixer, agitator, stirrer, etc.). The slurry feed conduit 5 can be structured as piping, tubing, or other type of conduit and can include one or more valves or other flow control mechanisms.

The mixer unit 7 can have at least one agitator 7a that is moved to stir or otherwise agitate the slurry within the mixer unit 7 for subsequently feeding the slurry to one or more filtration devices 10. The mixer unit 7 can be configured as a mixer or other type of slurry collection and agitation mechanism. In some embodiments, the mixer 7 can have agitators 7a that are configured as impellers for stirring the slurry and driving output of the slurry to one or more filtration devices 10. A filtration device feed conduit 9 can be a pipe, tube, or other type of conduit that extends from the mixer unit 7 to the filtration devices for transporting the slurry from the mixer 7 to the filtration device(s) 10. It should be appreciated that the filtration device feed conduit 9 can include valves and have sensors attached thereto or positioned therein.

One or more of the devices of the filtration system 1 can have sensors connected to at least one controller (e.g. a programmable logic controller (“PLC”), etc.) as well as other process control elements. For instance, the slurry feed conduit 5 can have a control valve 5a that can be opened and closed to control a rate at which slurry from the tank 3 is fed to the filtration devices 10 via the mixer 7. The control valve 5a can be fully opened, partially opened or closed to adjust the rate at which slurry is fed to a slurry bath 14 and/or a density of the slurry that is to be within the slurry bath 14 being fed via the slurry feed conduit 5. The filtration system 1 can also include a specific gravity sensor 5b and a flow sensor 5c connected to the slurry intake conduit 5 for measuring the flow rate and specific gravity of the slurry to monitor those process variables and control them so the flow rate and specific gravity of the slurry are within a pre-selected specific gravity range and a pre-selected flow rate range. These parameters can be adjusted or otherwise controlled for controlling the slurry level and slurry density within the slurry bath 14. For instance, the pre-selected ranges for flow rate and the slurry specific gravity can be defined by user selected set-points that account for a particular filtration system design, the material to be filtered, and other design criteria and operational criteria. An automated process control system can be connected to the control valve 5a, specific gravity sensor 5b, and flow sensor 5c to monitor and control operations of the filtration system 1. Other filtration system mechanism (e.g. mixer 7, filtration devices 10, mixer output conduit 9, tank 3) can also have one or more sensors and/or valves included therein connected to at least one controller of an automated process control system of the filtration system.

In some embodiments, the filtration system 1 can be configured so it does not utilize a mixer unit 7. For example, some embodiments of the filtration system 1 can connect the tank 3 to a single filtration device or a plurality of filtration devices via a slurry feed conduit 5 that extends from the tank 3 to the filtration device(s) 10. The slurry feed conduit (as well as tank 3 and the filtration device(s) 10) can include at least one valve and one or more sensors connected to at least one controller of an automated process control system of the filtration system 1.

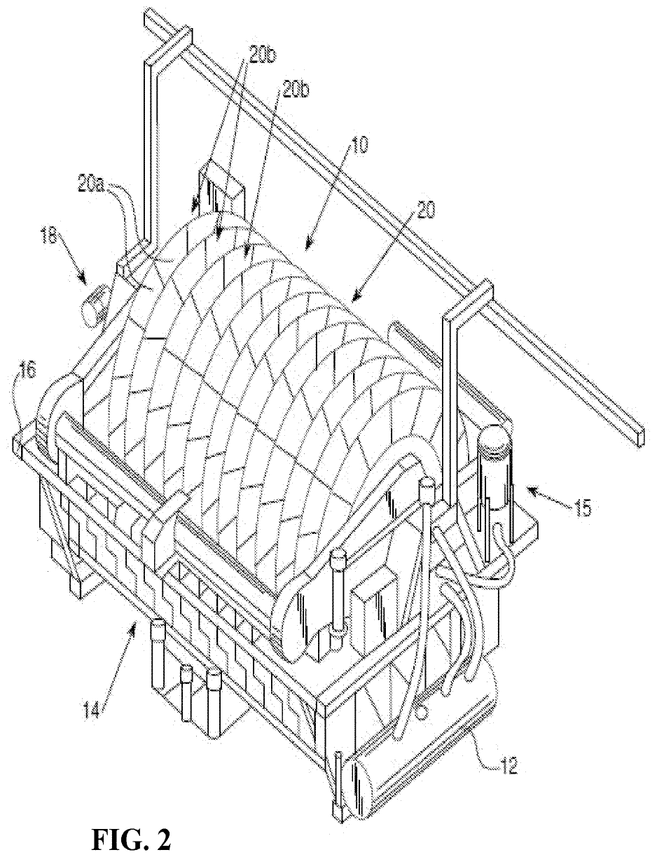

The filtration device(s) 10 of the filtration system 1 can best be appreciated from FIGS. 2-9. For example, each filtration device 10 can be configured as a rotary filter having an array 20 of discs 20b supported by bearings on a frame 16. The discs 20b can be positioned to be rotated via rotation of the shaft to which the discs 20b are connected so that disc sectors 20a of each disc pass through a reservoir of the slurry bath 14 during a full revolution of the disc 20b as that disc rotates. For instance, in some embodiments, the array 20 of discs 20b can be rotatable about a horizontally extending shaft having a first end, a second end, and an intermediate portion between its first and second ends. A drive mechanism can be attached to a shaft about which the array 20 of discs 20b rotates to drive rotation of the shaft to rotate the discs 20b. The drive mechanism can include an electric motor, a gear box, or other type of shaft rotating drive device.

The frame 16 of each filtration device 10 can be connected to a hood so that the array 20 of discs 20b is fully enclosed within a housing. The hood can permit the enclosed space in which the array 20 of discs 20b and slurry bath 14 are positioned. This can permit embodiments of the filtration device 10 to be operated at a desired pressure or temperature in the event operations can be improved by operating under a vacuum condition, operating at a pressure that is higher than atmospheric pressure, or operating at a controlled atmosphere. For example, inert gas steam or other gas can be passed into the space within the hood to define a desired atmosphere in which the slurry bath 14 and array of discs 20b are positioned. As another example, the temperature and pressure of the inner space defined by the hood can be maintained within pre-selected temperature and pressure ranges.

The hood can also help avoid contaminant material from a plant environment in which the filtration system 1 is positioned from entering the slurry bath 14 or discs 20b of the array 20. It should be appreciated that some embodiments of the filtration device 10 may not include a hood. Such embodiments may be configured as an open system that operates at atmospheric pressure and temperature conditions (though certain flows fed to the array 20 of discs 20b may be at different temperatures or pressures).

The frame 16 can also support a slurry overflow tank 12. The slurry overflow tank 12 can be positioned adjacent the slurry bath 14 (e.g. around a periphery of the bath) and can be in fluid communication with the slurry bath 14 to receive overflow of the slurry bath 14 (e.g. a flow of slurry that may rise over the upper edges of the slurry bath 14.

The array 20 of discs 20b can be configured and positioned so that as the array 20 of discs 20b rotates, filter elements of disc sectors 20a of the filter discs 20b are submerged within a slurry bath 14 adjacent a bottom of the array 20 of discs 20b. The filter elements can be filter media of each disc sector 20a.

Filter media can be attached to each disc sector 20a so that a first side of each disc sector has filter media on an outer face of that first side and a second side of the disc sector that is opposite the first side also has filter media on an outer face of that second side. The filter media of the first side can face away from the filter media of the second side and the filter media of the second side can face away from the filter media of the first side so the filter media of these sides are on opposite peripheral sides of the disc sector. Each disc sector can have a cavity defined therein between the first side and outer side (and between the filter media of the first side and filter media of the second side).

The array 20 of discs 20b can include a number of separate peripheral discs 20b that each have an array of disc sectors 20a that are attached to define the disc 20b. The disc sectors 20a can include frames 32 that are sized and configured to attach filter elements FE to the disc 20b. Each filter element FE can include filter media, which can be structured as a mesh or web material that has an array of passageways a sized to permit the fluid of the slurry (e.g. liquid or gas) to pass through the filter element while also retaining solid particulate material entrained within the slurry on the filter element so that an accumulation of the solid particulates forms a filter cake on the filter element. The filter elements FE can include ceramic material (e.g. a sintered alumina filter media), a cloth filter material, or a filter element that includes a metal wire mesh body that is at least partially coated on an outer surface with a layer of filtering material that includes particulate material cured onto the outer surface of the mesh body via a binder (e.g. a polymeric material, an epoxy, polyurethane, other type of binder as discussed herein, etc.). Examples of such filter elements and filter media can be appreciated from my U.S. Patent Application Publication No. 2022/0143536, the entirety of which is incorporated by reference herein. The filter media of the filter elements can include pores or interstices through which liquid of a slurry or a gas of a slurry can pass while retaining solid particulates on the filter media for formation of filter cake on the filter media.

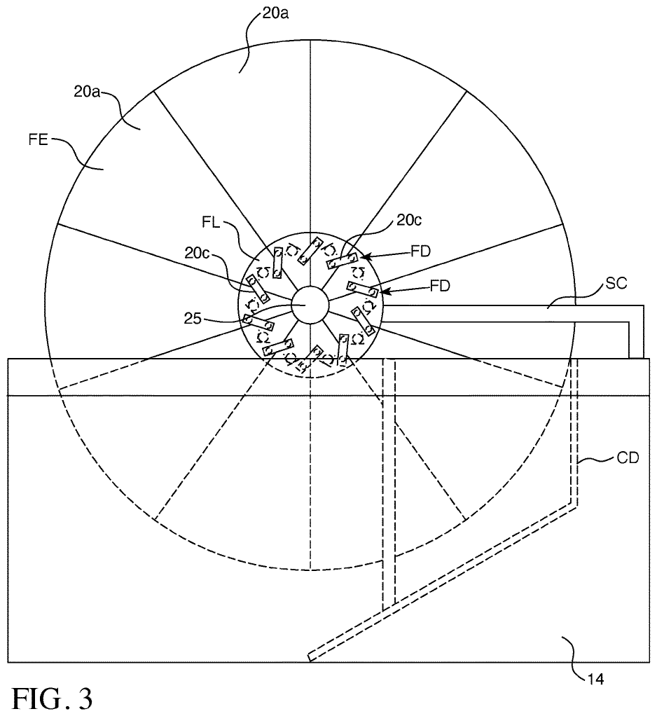

The operation of the filtration device(s) 10 may best be appreciated from FIG. 3. Slurry that can include a liquid having solid particulates entrained therein can be fed from the filtration device feed conduit 9 into the slurry bath 14. An agitator can be positioned in the slurry bath to stir or agitate the slurry within the bath to help keep the solid particulates within the slurry entrained therein to help avoid the solid particulates collecting on the bottom of the bath. The agitator can be structured as an impeller, a sweep mixer, or other type of agitation mechanism.

During operation, the array 20 of discs 20b can be rotated at a pre-selected rotational speed. The pre-selected rotational speed can be in the range of 0.5-10 revolutions per minute (RPM), 1-10 RPM, 0.5-8 RPM, or 1-8 RPM for some embodiments. Many embodiments can operate at a relatively high rotational speed of over 1 RPM, which can provide for a significant increase in operational capacity and efficiency.

The array 20 of discs 20b can be rotated so that the filter discs 20b of the array 20 that have disc sectors 20a are inserted into the liquid slurry of the slurry bath to collect the slurry. About 15°-180° of the 360° rotation of the array 20 of discs 20b can be the extent of the rotation path that involve a disc sector 20a being within the reservoir of the slurry bath 14 for collecting the slurry in a slurry insertion/collection zone or phase of the revolution. For example, some embodiments can be configured so that a disc sector 20a of each disc is within the slurry bath for 5°-15, 5°-45°, 30°-60°, 45°-90°, or 30°-120° of the 360° rotation of the disc sector 20a of the disc 20b for a single revolution of the disc sector 20a of the disc 20b.

It should be appreciated that the extent to which a disc sector 20a is within a reservoir of slurry in the slurry bath for the insertion phase can be affected by the height of slurry within the reservoir of the slurry bath 14. Some embodiments of the filtration device 10 can be configured so that the slurry bath has a high overflow position (e.g. the slurry is at a greater height and is closer to the rotational axis of the discs 20b as compared to embodiments having a slurry bath at a lower overflow position). When the slurry bath has a greater height of slurry (e.g. a higher overflow position), the insertion phase may extend for a longer duration of a single revolution as compared to when the slurry bath has a lower height, or a lower overflow position. This can also affect the extent to which a drying phase may be present in a single revolution (e.g. with a higher overflow position, the drying phase may make up a smaller portion of a revolution as compared to embodiments utilizing a slurry bath with a lower overflow position).

As the array 20 of discs 20b continues to rotate in a single revolution after exiting the slurry bath 14, the disc sectors 20a of the discs 20b can pass through a spraying zone (or phase) in which at least one fluid is sprayed onto the disc sectors 20a to facilitate washing, treating, and/or separation of the solid particulates from the fluid of the slurry. The spraying zone or phase of a revolution of the array 20 of discs 20b can be an optional aspect and may not be necessary for operations due to the solid particulates being filtered and the composition of the fluid of the slurry.

After the optional spraying zone or phase of the revolution of the discs 20b (or immediately after the disc sector 20a passes out of the slurry bath 14 when the spraying is not needed or used), the disc sector 20a can undergo a drying zone or phase during a revolution of the discs 20b at which the liquid of the slurry drains from the disc sector and the solid particulates retained by the filter element are dried due to gas flow (e.g. air flow or gas flow within a controlled atmosphere surrounding the discs 20b within a space at least partially defined by a hood, etc.) from the speed at which the array 20 of discs 20b rotates (which can be further facilitated by application of a vacuum). The drying phase can range from 30°-330° of the 360° rotation of the discs 20b about the horizontal shaft 25 or a horizontal axis. During the driving phase, the cavities of the disc sectors may have a vacuum applied to help facilitate drying.

The final phase of the revolution that the disc sectors 20a can undergo during a single revolution of the array 20 of discs 20b is the scrape/discharge zone or phase that occurs in a revolution after the drying or dewatering phase. In this final phase, the dried (or mostly dried) filter cake formed on the filter elements FE of the disc sector 20a is scraped off the filter element(s) and/or otherwise removed from the filter element(s) and distributed to a discharge chute DC supported on the frame 16 to transport the solid particulates to another processing device that is downstream of the filtration device 10. The scrape/discharge zone or phase of the rotation of the disc sector 20a in a single revolution can be less than 1°, up to 1°, up to 5°, or between 0.25°-5° of the 360° rotation of the disc sector 20a of a disc 20b. In other embodiments, the scrape/discharge zone can be up to 10°, between 1°-10°, up to 15°, up to 20°, or up to 30° of the 360° rotation of the disc sector 20a of a disc 20b that rotates about the horizontal shaft 25 or a horizontal axis. Each disc sector 20a can pass through these phases during a single revolution of the discs 20b of the array 20.

A vacuum can be applied to the cavity of the disc sector while it passes through the discharge zone to facilitate the removal of filter cake off of the filter elements (e.g. off the filter media) for passing to the chute. A scraper SC can also (or alternatively) be utilized to facilitate scraping off of the filter cakes from the outer surfaces of the filter elements FE of the disc sector 20a when the disc sector 20a passes through the scrape/discharge zone or phase of the rotation of the disc sector 20a during a full revolution of rotation of the disc sector 20a.

After the scrape/discharge phase, the disc sectors 20a of the discs 20b return to the slurry insertion/collection phase and continue to repeat the cycle of phases as the discs 20b rotate about the shaft 25 for further revolutions. It should be appreciated that for each revolution, a disc sector 20a can go through all of these phases (slurry/insertion phase, optional spraying phase, drying zone phase, and scrape/discharge phase in sequence.

Each disc sector 20a can be configured so it can receive pressurized fluid (e.g. a compressed gas or gas) and direct that pressurized fluid to an adjacent disc sector when the adjacent disc sector is being passed through a reservoir of the slurry bath 14 for being in contact with the liquid of the slurry to collect particulates from within the slurry. The disc sector 20a that receives the pressurized fluid PF can be above the adjacent fluid and be configured to facilitate the flow of the pressurized fluid from that disc sector to a cavity of the adjacent disc sector within the reservoir of the slurry bath so that the pressurized fluid PF is passed into that adjacent disc sector and passed into and/or through the filter media of the disc sector and into the slurry (and/or out of filter media while the disc sector is just above the slurry within the reservoir and after the filter cake was discharged from the disc sector). The passing of the pressurized fluid into and/or through the filter media while the filter media is in contact with liquid of the slurry (and/or prior to it being in contact with the liquid of the slurry) can facilitate cleaning of the filter media by removing remaining particulate material that can be retained on the filter media (e.g. within interstices or pores of the filter media) after the filter cake formed hereon was discharged from the filter media. It has been surprisingly found that having such pressurized fluid PF utilized in this manner can greatly improve cleaning of the filter media to avoid having to repeatedly expose the filter media to pressurized washing performed manually by personnel while a filtration device 10 may be shut down, which can greatly reduce operational downtime of the device and greatly improve the operational performance and operational capacity of the filtration device 10.

Each disc sector 20a can be configured so that its filter media is exposed to a vacuum at the same time the pressurized fluid PF is being passed from that sector to the adjacent sector within the slurry bath reservoir. This can occur while the disc sector is passed through the scrape/discharge phase and the adjacent disc sector has just entered the insertion phase. The application of the pressurized fluid may occur for an entirety of the insertion phase or only for a short duration of only part of the insertion phase. It has been found that application of the pressurized fluid PF can increase cleaning of the filter media of each disc sector 20a while still permitting filter cake collection and formation on the filter media after the insertion phase and drying phase of each revolution so the filter cake can be discharged from the filter media during the scrape/discharge phase of a revolution.

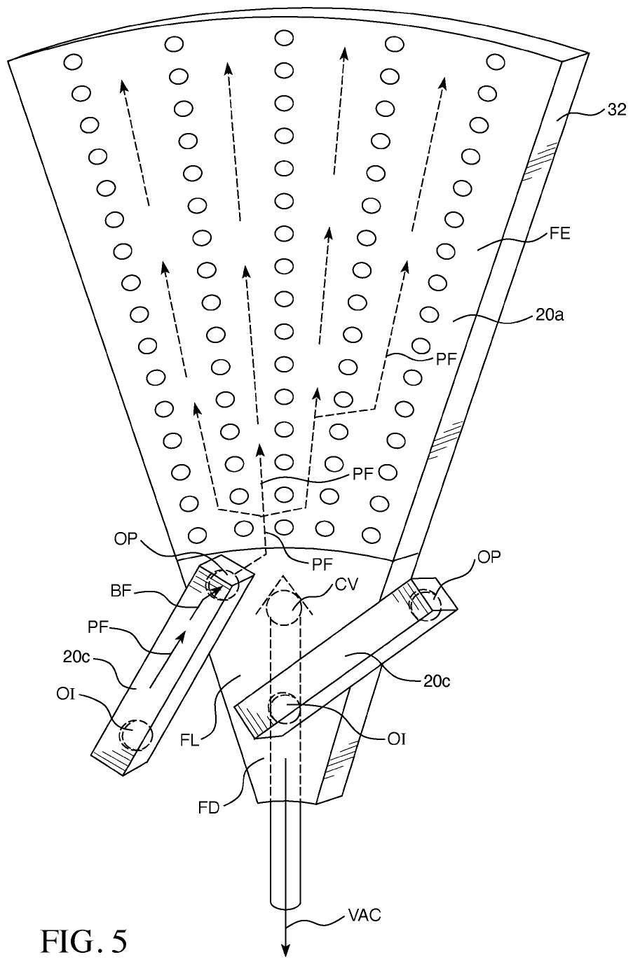

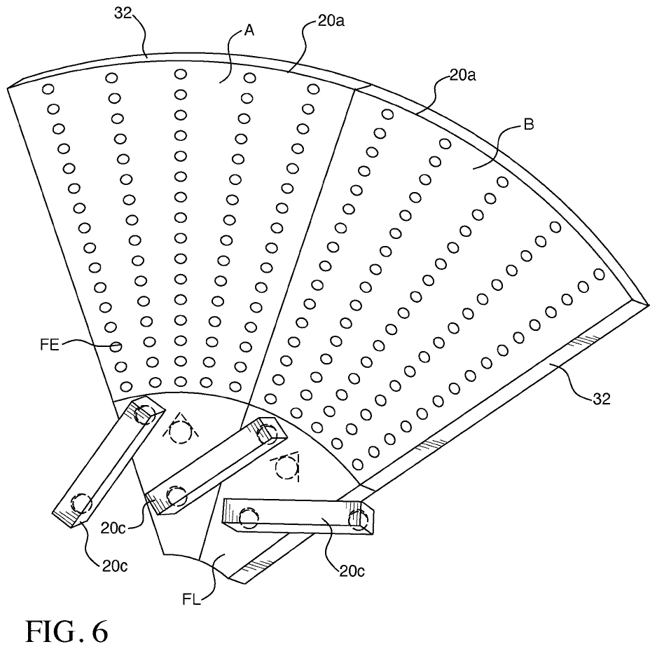

FIGS. 5 and 6 illustrate an exemplary disc sector 20a configuration to facilitate the flow of pressurized fluid PF to the adjacent sector B while the disc sector 20a (sector “A”) is passing through the scrape/discharge phase and is exposed to a vacuum. At this time the adjacent sector B receives the pressurized fluid PF from the disc sector (sector “A”), the adjacent sector B has undergone filter cake discharge and is within the slurry and/or about to be passed through the slurry.

As may best be seen from FIGS. 5 and 6, each disc sector 20a can be configured to include a check valve CV positioned to prevent pressurized fluid PF from passing into a cavity of that disc sector 20a while that disc sector is exposed to a vacuum and is rotated in the scrape/discharge phase. For instance, a hinged check valve can be positioned so it rotates or moves to facilitate the closing off of the cavity while pressurized fluid PF is fed into the disc sector to direct that pressurized fluid PF to the adjacent sector (sector B) that is in the insertion phase of its revolution. The check valve of sector B can be in a closed position to force the pressurized fluid PF to pass into and through the pores or interstices of the filter media while the filter media is within the reservoir of the slurry bath and in contact with the slurry. In some configurations, the pressurized fluid can be passed from the sector A to the adjacent sector B that has already undergone filter cake discharge via passing fluid from within sector A that is below a check valve of sector A and into the sector B so that the fluid is passed into sector B above the check valve in sector B for being passed through the cavity and filter media of sector B.

For example, the hinge check valve position can be moved via the pressurized fluid and rotational force applied to the disc sector 20a to cause the hinge to block a vacuum port that can expose the cavity to a vacuum to permit the pressurized fluid PF to pass into the cavity of the adjacent disc sector B. When the disc sector is moved out of the reservoir, the hinge can move to block the pressurized fluid path and permit the disc sector to again be exposed to a vacuum during the drying phase of the revolution of the disc sector as well. As the disc sector moves along its rotational path for a revolution, the hinge can move when the disc sector again enters the insertion phase to facilitate receipt of the pressurized fluid from the adjacent disc sector that is passing through its discharge/scrape phase. A torsion spring can be positioned adjacent the hinge and check valve to help facilitate motion of the hinge for adjusting the flow path for the pressurized fluid and vacuum as well.

In some embodiments, the check valves can be ball check valves and/or high flow rate check valves. Such check valves can facilitate providing of the adjustable flow path. Other check valves and conduit or passageways can be provided as an alternative in other embodiments.

As may best be seen from FIGS. 3-6, the check valve CV can be in fluid communication with a pressurized fluid conduit 20c that can be positioned to extend on an exterior surface of the frame 32 of the disc sector 20a to transport pressurized fluid PF from an adjacent disc sector 20a to that disc sector 20a. Each disc sector 20a can be connected to at least two pressurized fluid conduits 20c. Each pressurized fluid conduit 20c can be positioned adjacent external sides of the disc sectors 20a to which the pressurized fluid conduit 20c is connected. For instance, a first pressurized fluid conduit 20c can be connected for conveying pressurized fluid to that disc sector 20a and a second pressurized fluid conduit 20c can be connected to the disc sector for conveying pressurized fluid from that disc sector to an adjacent disc sector 20a so that these disc sectors are positioned on external sides of the frames 32 of the disc sectors to which they are connected.

For example, a first pressurized fluid conduit 20c can be structured as a tubular or polygonal shaped (e.g. rectangular, etc.) member having an inner passageway therein having a first end having an opening structured as an inlet OI connected adjacent to a check valve CV of a first disc sector 20a and a second end having a disc sector feed opening OP attached to an adjacent disc sector 20a so that pressurized fluid PF can be passed from an adjacent disc sector having the check valve to that disc sector 20a for being passed into an inner cavity defined by the frame 32 of the filter element and out of the holes of the filter element to facilitate cleaning of the filter element and, when the pressurized fluid PF is passed into the disc sector while it is in the slurry bath's reservoir, facilitating bubbling in the slurry within the slurry bath 14 as the pressurized fluid is output from the filter element FE of the disc sector 20a.

The filter element FE can be positioned on an outer section, or distal section of the disc sector 20a relative to an inner shaft connecting section FL of the disc sector 20a. The inner shaft connecting section FL can be a proximate section of the disc sector 20a that is proximate the rotating shaft 25 to which the disc sector 20a is connected. The inner shaft connecting section FL can include fluid distribution components FD for routing of pressurized fluid (e.g. first and second pressurized fluid conduits 20c, a check valve CV, etc. that can be in fluid communication with a cavity of the disc sector that is defined in the frame 32 to which at least one filter element FE is attached).

The second pressurized fluid conduit 20c can be positioned so that the inlet OI of the second pressurized fluid conduit 20c is in fluid communication with the check valve CV of the disc sector within the frame 32 to receive the pressurized fluid PF for closing the check valve CV and/or feeding the pressurized fluid through the inlet IO of the second pressurized fluid conduit 20c so that the pressurized fluid can be passed through the passageway of the second pressurized fluid conduit 20c and output into an adjacent disc sector 20a via the disc sector feed opening OP of the second pressurized fluid conduit that is attached to an adjacent disc sector 20a so that pressurized fluid can be passed from the disc sector into the adjacent disc sector when that adjacent disc sector is within the slurry bath and/or after the filter element of the adjacent disc sector has undergone scraping and/or filter cake discharge for cleaning of the filter element FE of the adjacent disc sector.

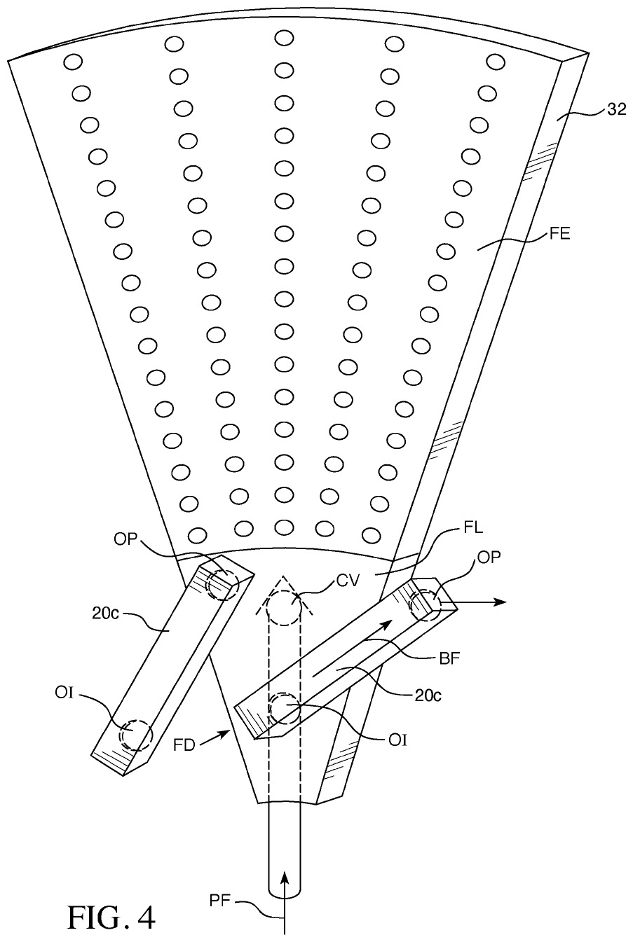

The pressurized fluid pathway as the pressurized fluid PF is passed from a disc sector that was fed that pressurized fluid PF to the adjacent disc sector that is undergoing cleaning (e.g. has already been scraped/had the filter cake discharged and/or is in the slurry bath) is shown via flow path arrows BF in FIGS. 4 and 5, for example. An exemplary vacuum flow path of fluid that the disc sector can also experience is indicated via flow path arrow VAC in FIG. 5. The check valve CV of the disc sector 20a can be configured to be in an open position for the application of vacuum. When the pressurized fluid PF is fed to the disc sector, this can trigger closing of the check valve to subsequently divert the pressurized fluid to the second pressurized fluid conduit 20c for feeding that pressurized fluid to the adjacent disc sector 20a (e.g. sector B shown in FIG. 3 when this particular disc sector is in the position of sector A). Each disc sector 20a of the disc 20b of disc sectors 20a can include these first and second pressurized fluid conduits 20c for application of pressurized fluid and vacuum during a full revolution of the disc 20b. Each disc 20b attached to a shaft 25 can include such an arrangement of disc sectors 20a having first and second pressurized fluid conduits 20c as well.

In some configurations, the vacuum that the disc sector may experience while it is passing pressurized fluid PF to an adjacent sector (e.g. sector B), can be decreased. For example, the check valve CV of the sector can be in fluid communication with a tube manifold that facilitates the application of the vacuum and the check valve may close in response to the application of the pressurized fluid for directing of the pressurized fluid to the adjacent sector (e.g. sector B). However, a vacuum may still be conveyed via the OP of the disc sector feed opening OP of the first pressurized fluid conduit to which the disc sector is connected. As another alternative, a separate vacuum inlet can be provided for application of the vacuum so that the vacuum can be applied with the pressurized fluid is also applied for being directed to the adjacent sector.

Each of the first and second pressurized fluid conduits 20c can be positioned on only a single side of each disc sector 20a. In other embodiments, there can be multiple first pressurized fluid conduits 20c and also multiple second pressurized fluid conduits 20c positioned on opposite sides of the disc sector 20a (e.g. two first pressurized fluid conduits 20c in which they are positioned on opposite sides of the disc sector 20a and two second pressurized fluid conduits 20c in which they are positioned on opposite sides of the disc sector 20a).

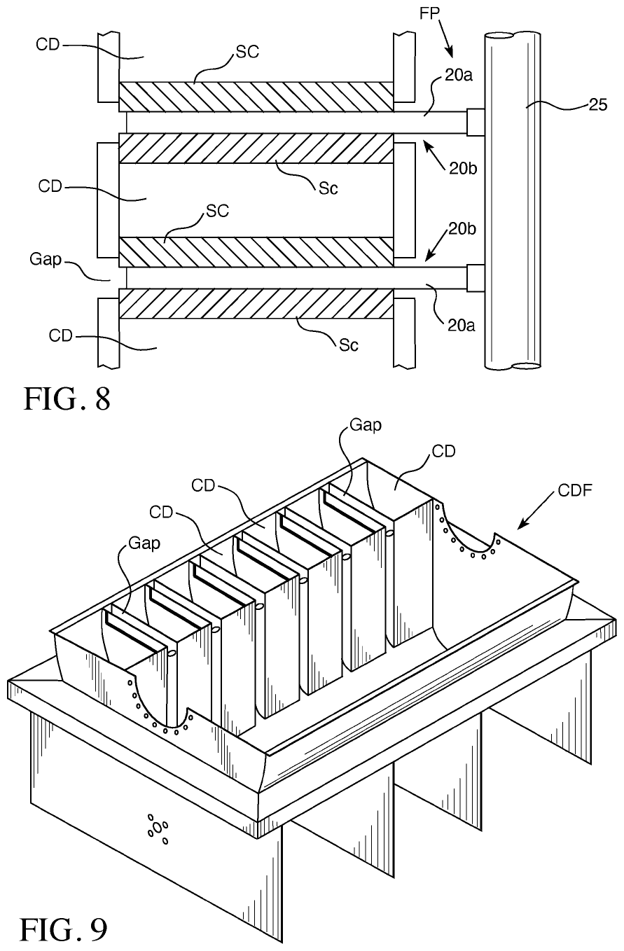

As may best be seen from FIGS. 8 and 9, the slurry bath 14 can be connected to a cake discharge frame CDF having multiple cake discharge chutes defined therein for receipt of filter cake for guiding the filter cake into a cake discharge conduit or cake discharge storage device (e.g. cake discharge box). The cake discharge frame CDF can include multiple discharge chutes CD that are positioned below scrapers SC and/or adjacent the scrapers SC. There can be gaps (gap) between adjacent discharge chutes CD to accommodate the discs 20b so that each disc 20b can pass through a respective gap and rotate without hitting or contacting the discharge chutes CD while filter cake on filter elements of the disc sectors 20a of the discs 20b can be scaped and/or removed from the disc sectors via contact with the scrapers SC and passed through the discharge chutes CD. In retrofit situations, the cake discharge frame CDF can be provided so that it can be positioned in connection with the slurry bath 14 for being positioned on or over a cake discharge chut or other filter cake opening or conduit. In new installation situations, the slurry bath 14 and frame 16 can be configured to integrate the cake discharge frame CDF with discharge chutes CD and scrapers SC.

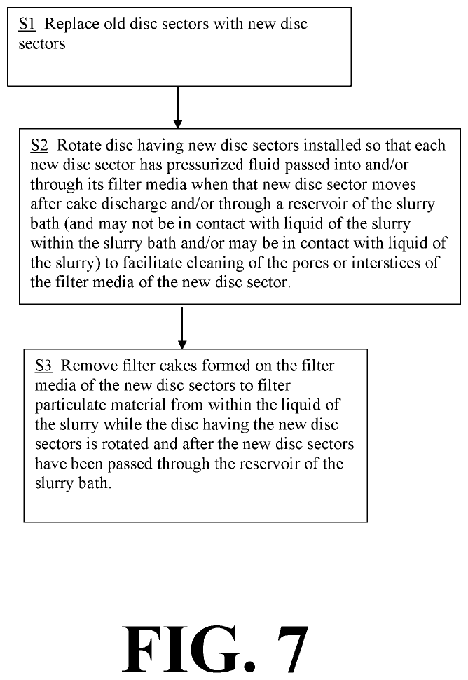

Referring to FIG. 7, a process for retrofitting a pre-existing filter apparatus or filter device 10 is provided. Old conventional disc sectors can be removed from a disc 20b and replaced with new disc sectors 20a (e.g. embodiments of disc sectors 20a discussed above, etc.). In a first step S1, the new disc sectors can be positioned to reform the disc 20b so the disc now has the new disc sectors 20a. The disc can then be rotated in a second step S2. The rotation of the disc 20b can be performed so that the new disc sectors have pressurized fluid PF passed into and/or through its filter media when the new disc sector moves through a reservoir of the slurry bath 14 and is in contact with liquid of the slurry to facilitate clearing of the pores or interstices of the filter media of the new disc sector 20a. The new disc sectors can also (or alternatively) have pressurized fluid PF passed into and/or through its filter media after the filter cakes were discharged from the new sectors and just before the new disc sector moves through a reservoir of the slurry bath 14 (e.g. prior to the disc sector being moved into contact with liquid of the slurry to facilitate clearing of the pores or interstices of the filter media of the new disc sector 20a). In a third step S3, filter cake formed on the filter media of the new disc sectors can be removed to filter particulate material from within the slurry while the disc having the new disc sectors is rotated and after the new disc sectors have been passed through the reservoir of the slurry bath. A vacuum can be applied during the removal of the filter cake and the pressurized fluid PF can be directed from that disc to an adjacent disc that is within its insertion phase of its revolution as discussed above during the filter cake removal step.

It should be appreciated that embodiments of the process can include other steps as well. For example, embodiments of the process can also include cake removal, scraping, and/or maintenance related features. As another example, the process can also include a step of including a discharge chute array for positioning in the slurry bath to facilitate scraping and discharge of filter cake off the disc sectors 20a of the discs 20b attached to the shaft 25.

It should also be understood that the foregoing is provided for illustrative and exemplary purposes; the present invention is not necessarily limited thereto. Rather, those skilled in the art will appreciate that various modifications, as well as adaptations to particular circumstances, are possible within the scope of the invention as herein shown and described. For instance, different embodiments may be designed to meet a particular set of design criteria. As another example, the size and configuration of different elements and the material for those elements can be designed for a particular operational objective (e.g. filtration of a particular type of mineral from a liquid slurry, filtration of a particular set of solid particulates from a slurry, a size and layout of the facility in which at least one filtration device is to be incorporated, operational parameters at which the facility that will include one or more filtration devices is to operate, etc.).

As yet another example, it should be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement. Therefore, while certain exemplary embodiments of filter devices, filtration apparatuses used to remove solid particulates from a slurry, and methods of making and using the same have been shown and described above, it is to be distinctly understood that the invention is not limited thereto but may be otherwise variously embodied and practiced within the scope of the following claims.

1. A filtration device comprising:
at least one rotatable disc that is rotatable so disc sectors are insertable into a slurry bath positioned adjacent the at least one rotatable disc, the disc sectors configured to form filter cakes comprised of solid particulate material of the slurry via rotation of the at least one rotatable disc about a shaft;
each of the disc sectors having:
a frame, the frame connected to at least one filter element, the frame having a cavity, the frame connectable to the shaft about which the disc rotates so that a vacuum is appliable to the cavity and a pressurized fluid is passable to the disc sector;
a first pressurized fluid conduit connected to the frame for conveying pressurized fluid to the disc sector, a disc sector feed opening of the first pressurized fluid conduit in fluid communication with the cavity so that the pressurized fluid is passable through the first pressurized fluid conduit and into the cavity;
a second pressurized fluid conduit connected to the frame such that an inlet of the second pressurized fluid conduit is positioned to receive the pressurized fluid for feeding the pressurized fluid through an inner passageway of the second pressurized fluid conduit so that the pressurized fluid is outputtable into a cavity of an adjacent one of the disc sectors while the adjacent disc sector is within the slurry bath and/or after the at least one filter element of the adjacent disc sector has undergone filter cake discharge for cleaning of the at least one filter element of the adjacent disc sector.

2. The filtration device of claim 1, comprising:
the shaft, the shaft having a tube manifold connectable to the disc sectors.

3. The filtration device of claim 1, wherein the second pressurized fluid conduit has disc sector feed opening in communication with a cavity of the adjacent sector.

4. The filtration device of claim 1, wherein each of the disc sectors has a check valve positioned in fluid communication with the inlet of the second pressurized fluid conduit.

5. The filtration device of claim 4, wherein the check valve is adjustable to a closed position in response to the passing of the pressurized fluid to the disc sector to direct the pressurized fluid through the second pressurized fluid conduit so the pressurized fluid is passed to the adjacent disc sector.

6. The filtration device of claim 1, comprising:
at least one filter cake discharge chute positionable adjacent the disc to receive filter cake discharged from the disc sectors.

7. The filtration device of claim 1, comprising:
a cake discharge frame having multiple cake discharge chutes defined therein for receipt of the filter cakes, the cake discharge frame connectable to the slurry bath.

8. The filtration device of claim 7, wherein the at least one disc includes multiple discs and the cake discharge frame is configured to define the discharge chutes so that there are gaps positioned between the discharge chutes, each of the discs being positionable within a respective one of the gaps.

9. A method of filtering, comprising:
rotating a disc having disc sectors so that each of the disc sectors has pressurized fluid passed into the disc sector for being directed into one of the disc sectors adjacent to the disc sector after the adjacent disc sector has had filter cake discharged from at least one filter element of the adjacent disc sector to facilitate cleaning of pores or interstices of filter media of at least one filter element of the adjacent disc sector.

10. The method of claim 9, wherein the rotating is performed such that the pressurized fluid is passed into the adjacent disc sector while the adjacent disc sector is rotated through a slurry bath.

11. The method of claim 10, comprising:
passing the pressurized fluid out of the adjacent disc sector and into the slurry bath while the adjacent disc sector is passed through the slurry bath.

12. The method of claim 11, comprising:
removing filter cake from the at least one filter element before the adjacent disc sector is passed into the slurry bath.

13. The method of claim 12, wherein the removing of the filter cake includes scraping the filter cake off of the at least one filter element.

14. The method of claim 9, comprising:
installing the disc sectors on a rotatable shaft to form the disc.

15. The method of claim 9, comprising:
installing a cake discharge frame on a slurry bath adjacent the disc so that the disc is passable through a gap defined between adjacent, spaced apart discharge chutes.

16. The method of claim 9, comprising:
applying a vacuum to the disc sectors during the rotating of the disc.

17. The method of claim 9, comprising:
feeding the pressurized fluid into each of the disc sectors of the disc during a revolution of the disc so that the pressurized fluid is directed from the disc sector to a cavity of the adjacent disc sector so that the pressurized fluid is passed into the adjacent disc sector after the adjacent disc sector has had filter cake discharged from at least one filter element of the adjacent disc sector to facilitate cleaning of pores or interstices of filter media of at least one filter element of the adjacent disc sector.

18. A filtration method comprising:
passing pressurized fluid into a first disc sector of a disc that is rotatable about a horizontal shaft such that the disc is rotatable adjacent to a slurry bath;
passing the pressurized fluid from the first disc sector to a second disc sector of the disc that is adjacent the first disc sector so that the pressurized fluid is passed into a cavity of the second disc sector to clean pores or interstices of filter media of at least one filter element of the second disc sector.

19. The filtration method of claim 18, comprising:
passing the second disc sector through the slurry bath for filtering of particulates from liquid of slurry within the slurry bath.

20. The filtration method of claim 18, wherein the passing of the pressurized fluid from the first disc sector to the second disc sector so that the pressurized fluid is passed into the cavity of the disc sector to clean pores or interstices of filter media of the at least one filter element of the second disc sector includes:
passing the pressurized fluid through a pressurized fluid conduit connected between the first disc sector and the second disc sector while the second disc sector is within the slurry bath and/or after filter cake has been discharged from at least one filter element of the second disc sector, the pressurized fluid conduit being positioned adjacent external sides of the first disc sector and the second disc sector.

21. A process of retrofitting a filtration device, the process comprising:
connecting disc sectors to a rotatable shaft to form at least one rotatable disc that is rotatable so the disc sectors are insertable into a slurry retained in a slurry bath positioned adjacent the at least one rotatable disc during rotation of the shaft, the disc sectors configured to form filter cakes comprised of solid particulate material of the slurry via rotation of the at least one rotatable disc about the shaft;
each of the disc sectors having:
a frame, the frame connected to at least one filter element, the frame having a cavity, the frame connectable to the shaft about which the disc rotates so that a vacuum is appliable to the cavity and a pressurized fluid is passable to the disc sector;
a first pressurized fluid conduit connected to the frame for conveying pressurized fluid to the disc sector, a disc sector feed opening of the first pressurized fluid conduit in fluid communication with the cavity so that the pressurized fluid is passable through the first pressurized fluid conduit and into the cavity;
a second pressurized fluid conduit connected to the frame such that an inlet of the second pressurized fluid conduit is positioned to receive the pressurized fluid for feeding the pressurized fluid through an inner passageway of the second pressurized fluid conduit so that the pressurized fluid is outputtable into a cavity of an adjacent one of the disc sectors while the adjacent disc sector is within the slurry bath and/or after the at least one filter element of the adjacent disc sector has undergone filter cake discharge for cleaning of the at least one filter element of the adjacent disc sector.
